(19) United States
(12) Patent Application Publication
(10) Pub. No.: US 2023/0008816 A1
(43) Pub. Date: Jan. 12, 2023

(54) RADAR SYSTEM FOR MOTOR VEHICLES

(71) Applicant: Robert Bosch GmbH, Stuttgart (DE)

(72) Inventors: Marcus Steffen Reiher, Renningen (DE); Armin Himmelstoss, Weissach Im Tal (DE); Daniel Reisinger, Rottenburg-Wendelsheim (DE); Dirk Bodenschatz, Stuttgart (DE); Frank Meinl, Leonberg (DE); Juergen Hasch, Stuttgart (DE); Juergen Hildebrandt, Weilheim (DE); Martin Kunert, Rutesheim (DE); Thomas Binzer, Ingersheim (DE)

(21) Appl. No.: 17/856,743

(22) Filed: Jul. 1, 2022

(30) Foreign Application Priority Data
Jul. 8, 2021 (DE) 10 2021 207 201.1

(51) Int. Cl. G01S 13/00; G01S 13/931; G01S 13/87; G01S 7/40; G01S 13/34

(52) U.S. Cl. CPC G01S 13/003; G01S 13/931; G01S 13/87; G01S 7/4017; G01S 13/34; G06F 13/38

(57) ABSTRACT

A radar system for motor vehicles, with a plurality of transmit/receive units arranged on separate installation supports for installation at various locations in the motor vehicle, an evaluation system for evaluating the radar signals received on a plurality of channels in a plurality of processing steps, a first processing step delivering a digital time signal for each channel, which digital time signal represents the received radar signal, and a final processing step delivering as the result location data for individual radar objects and at least the final processing step being implemented for the plurality of transmit/receive units in a central evaluation unit with which the transmit/receive units in each case communicate via a raw data interface. The each of raw data interfaces has a serializer, which is configured to transfer raw data from the plurality of channels of the transmit/receive unit in question serially to the central evaluation unit.

### CROSS REFERENCE

The present application claims the benefit under 35 U.S.C. § 119 of German Patent Application No. DE 10 2021 207 201.1 filed on Jul. 8, 2021, which is expressly incorporated herein by reference in its entirety.

### FIELD

The present invention relates to a radar system for motor vehicles, with a plurality of transmit/receive units, which are arranged on separate installation supports for installation at various locations in the motor vehicle, and with an evaluation system for evaluating the radar signals received on a plurality of channels in a plurality of processing steps, a first processing step delivering a digital time signal for each channel, which digital time signal represents the received radar signal, and a final processing step delivering as the result location data for individual radar objects and at least the final processing step being implemented for the plurality of transmit/receive units in a central evaluation unit with which the transmit/receive units in each case communicate via a raw data interface.

### BACKGROUND INFORMATION

In driver assistance systems, for example for distance control and/or for collision warning or collision avoidance, and in systems for autonomous driving, radar systems are used for detecting the traffic environment. As performance requirements become ever more exacting, in particular with regard to the angular resolution of radar sensors, increasing use is being made of radar sensors with a large antenna aperture.

PCT Patent Application No. WO 2018/137809A1 describes a radar system for motor vehicles which has a plurality of mutually synchronized transmit/receive units, such that overall a large number of receive channels is available and high-resolution angle measurement is made possible by aligning the amplitudes and phases of the radar echoes received from multiple mutually offset antennas. It is also not ruled out in this case that the plurality of transmit/receive units are installed at relatively spaced-out positions in the motor vehicle.

The transmit/receive units typically operate in accordance with the FMCW (Frequency Modulated Continuous Wave) principle. The frequency of the transmitted radar signal is modulated in ramped manner. A succession of frequency ramps is transmitted within each measuring cycle. The radar echoes received in each receive channel are mixed with a component of the signal transmitted at the receive time, such that a lower frequency beat signal is obtained. Due to the distance dependence of the signal transit times and due to the Doppler effect, the beat frequency is dependent both on the object distance and on the relative speed of the object. Various methods are conventional with which the distance-dependent components and the speed-dependent components can be separated from one another. In general, the time signal recorded over the measuring cycle is converted, to this end, by a one- or multi-dimensional Fourier transform into a frequency spectrum in which each located object is distinguished by a peak at a specific frequency.

When using a plurality of sensors at various installation positions in the vehicle, already fully processed sensor signals (location data) have hitherto tended to be merged together. Novel vehicle architectures, e.g., for autonomous vehicles (SAE classes 4 and 5), require a significant increase in sensor performance. This may be achieved by a radar system of the above-stated type, as described for example in German Patent Application No. DE 10 2018 200 391 A1. In such a system, a plurality of sensors, distributed at multiple locations on the vehicle, operate as a cooperative interconnected system. In this way, additional information can be obtained (e.g. sensor A transmits from position X and sensor B receives the echo at position Y). For such an operating mode it may be necessary first of all to merge the unprocessed signals (“raw data”) from the individual sensors and then jointly evaluate them.

The installation space for sensors is often severely restricted in vehicles, with very strict requirements applying with regard to box volume and power consumption.

A modular structure of the radar system with operation of a plurality of independent radar sensor heads with or without greatly reduced signal processing, in which evaluation of the radar signal takes place on a central control device, allows these requirements to be more readily fulfilled.

In this way, the total number of ECUs in a vehicle can be reduced, and consequently costs can be lowered and synergistic effects achieved, providing the vehicle manufacturer with more flexible partitioning options. Combined operation of radar and video, lidar and other sensor modalities becomes possible, as do also data fusion at raw data level, enhanced performance due to software updates at ECU level without sensor head replacement, simpler integration (due to smaller box volume) at awkward locations in the vehicle, and easier heat dissipation at critical locations (due to reduced power loss in radar heads due to relocation of processor and ECU to a central or collective control device).

The increased complexity at vehicle level also results in a significantly greater variety of sensor types. A simple classification and optimization of different sensor types seems ever more difficult, since the large number of sensors per vehicle results in a very large number of possible combinations and sensor variants. Against this background, a modular platform concept, in which it is possible to derive specific sensor types from a common, generic platform, also appears desirable.

A suitable platform concept and the use of as many carry-over parts as possible in terms of hardware and software may also enable a reduction in development costs. Separating radar sensor head and evaluation unit enables the re-use of existing components and individual upgrading of individual modules (e.g., only radar heads or only the central unit). Moreover, a plurality of different types of sensor heads adapted to the respective use can be operated without having to adapt the backend for this purpose.

If the individual radar heads (transmit/receive units) are to have a high angular resolution capacity, however, a large number of parallel receive channels is needed, and then a correspondingly large number of transmission channels is also needed to transfer the raw data to the central evaluation unit. This complicates the wiring of the various vehicle system components. A large number of sensor heads in an individual vehicle may result in total cable lengths of an order of magnitude of 15 m or more, such that when multicore cables are used a large amount of space is needed for the cable harnesses and it is more difficult to install the cables.

### SUMMARY

An object of the present invention is to simplify the installation of a radar system of the above-mentioned type in a vehicle.

This object may be achieved according to the present invention in that the raw data interfaces in each case have a serializer, which is configured to transfer raw data from the plurality of channels of the transmit/receive unit in question serially to the central evaluation unit.

In accordance with an example embodiment of the present invention, through serialization of the raw data, which are to be transferred by the individual transmit/receive units to the evaluation unit, the required number of cores in the cables connecting the various components can be reduced to a fraction. In this way, material and space are saved and cable flexibility increased, such that difficult installation situations can be better managed.

Advantageous configurations of the present invention are disclosed herein.

The serializers may comprise separate components on a printed circuit board of the transmit/receive unit. Alternatively, the serializers may also be integrated at chip level into a radar MMIC or a processor of the transmit/receive unit.

Conventional physical serializers/deserializers make it possible, using specific hardware, to convert parallel data streams, for example the time signals arising on the various receive channels, into a serial data stream which transfers the time signals one after the other to the evaluation unit, such that in extreme cases just one single core is required in the transmission cable for the plurality of channels. Different interface standards, which allow high transmission rates of the order of magnitude of 15 Gbit/s or more, may be used for serial data transmission. The transmission cables may for example be coaxial cables or twisted pair lines. In one embodiment, transmission may also proceed via fiber optic cables, which allow a particularly high data rate.

Corresponding deserializers may be provided on the processing unit side which convert the serial signals back into parallel signals for the plurality of channels, such that further evaluation can again take place in parallel in the various channels.

The serially transmitted data may be digitized, unprocessed radar signals (time signals) or digitally preprocessed raw data. In this context, typical preprocessing steps are filtering, selection and compression.

In general, it is necessary to transmit monitoring and control information and optionally synchronization signals or indeed data for transmitter modulation from the evaluation unit (backend) to the transmit/receive units (frontends). Since, however, the data rate needed for this transmission path is markedly lower, it is feasible to use different bus systems and/or transmission protocols for the opposing transmission directions.

The various transmit/receive units may be synchronized with one another, so enabling a coherent data evaluation with which large antenna apertures and thus high angular resolutions can be achieved. Decoherent operation of the transmit/receive unit is however also possible, and likewise joint evaluation of the radar data of the transmit/receive units together with data from other sensor systems such as video, lidar and the like in one and the same central evaluation unit.

In accordance with an example embodiment of the present invention, to achieve time synchronization of a plurality of transmit/receive units with one another and/or with the evaluation unit, distributed clocks may be used, which are adjusted via a data interface. To adjust the clocks, a time stamp may, for example, be sporadically transmitted via the data interface. Alternatively, an individual pulse may also be sent at given, preset times. The clocks should be in a position to readjust the frequency deviations of their internal clock-pulse generator in accordance with the received time stamps.

The central evaluation unit may be implemented on one of the installation supports, but may also be implemented in a control device separate from the installation supports. One possible way of further reducing cable lengths is by bringing together multiple sensors in a spatially close control device (“zone control device”), before they are routed onward in bundled form to a central unit.

Exemplary embodiments are explained in further detail below on the basis of the figures.

### BRIEF DESCRIPTION OF THE DRAWINGS

FIG. 1 shows a top view of a motor vehicle with a radar system according to an example embodiment of the present invention.

FIG. 2 is a block diagram of the radar system of FIG. 1, in accordance with an example embodiment of the present invention.

### DETAILED DESCRIPTION OF EXAMPLE EMBODIMENTS

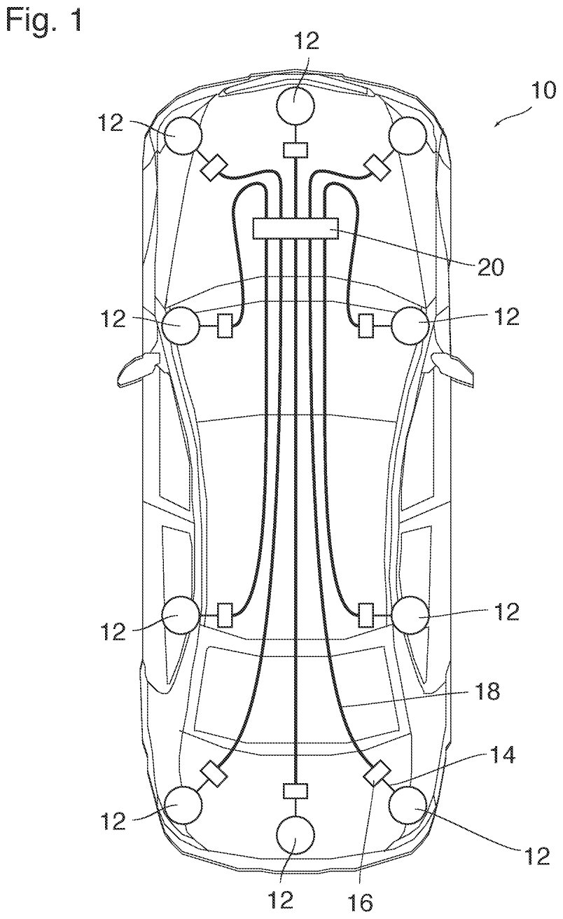

FIG. 1 is a schematic representation of a radar system of a motor vehicle 10. The radar system comprises a plurality of (ten in the example shown) transmit/receive units 12, which are installed separate from one another, in each case on their own installation support (printed circuit board or package), at different locations in the motor vehicle.

Each transmit/receive unit 12 has as signal output a raw data interface 14, which is connected via a physical serializer 16 and a cable 18 to a central evaluation unit 20, which evaluates the raw data of all the transmit/receive units 12.

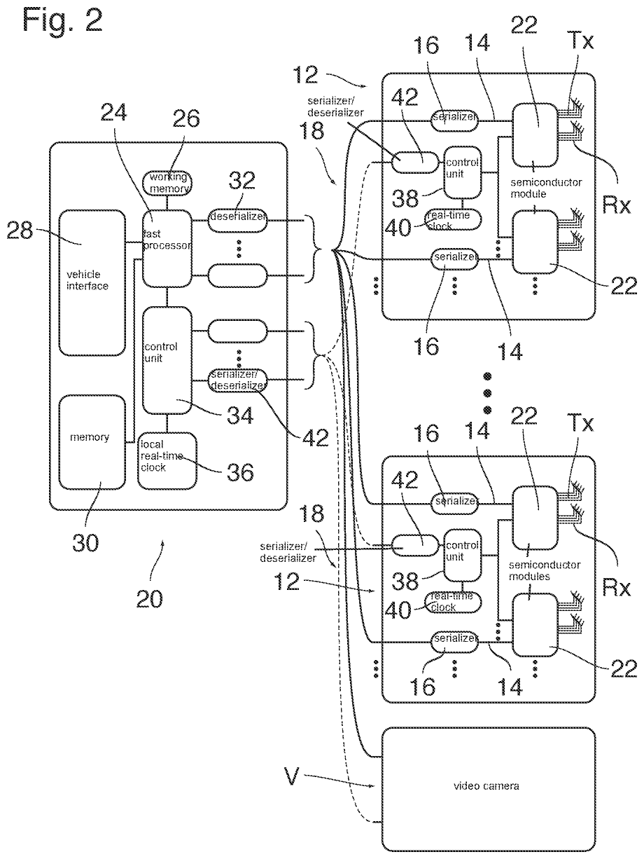

FIG. 2 shows the central evaluation unit 20 and two of the transmit/receive units 12 as separate blocks. Virtually the entire functionality of an individual transmit/receive unit 12 is implemented in one or more semiconductor modules 22, for example MMICs (Monolithic Microwave Integrated Circuits) or an SoC (system on chip). Antenna arrays of the transmit/receive unit 12 are represented only symbolically in the drawings and, in the example shown, comprise separate transmit antennas Tx and receive antennas Rx, which are arranged offset relative to one another in the horizontal direction in such a way as to achieve an angular resolution in azimuth.

It may be assumed, by way of example, that the radar system shown here operates according to the FMCW principle. The transmit antennas of each transmit/receive unit 12 transmit a succession of radar signals frequency modulated in ramped manner in each measuring cycle. The signals reflected at the located objects are received by the receive antennas and mixed with a component of the signal transmitted at the receive time, such that a low-frequency beat signal is obtained for each antenna element, the frequency and phase of which obtains the distance and relative speed information about the located object. These beat signals are evaluated for each receive antenna in a separate receive channel of the semiconductor module 22. In this case, the complex amplitudes of the beat signals are sampled and digitized at a high cycle rate over the duration of the measuring cycle. The digitized data form raw data, which are transferred to the central evaluation unit 20 via the raw data interface 14.

In the example shown, the central evaluation unit 20 is formed by a control device, which also controls the functions of the transmit/receive units and in which the time signals of all the transmit/receive units 12 are jointly evaluated in a fast processor 24 with associated working memory 26. In the course of evaluation, the time signal is converted in each receive channel by fast Fourier transform into a spectrum in which each located object is distinguished as a peak at a specific frequency. By aligning the data obtained at various frequency ramps, the distance information is separated in conventional manner from the relative speed information, such that the distance and the relative speed of each located object can be determined. Furthermore, by comparing the amplitudes and phases of the signals received in different receive channels, the azimuth angle of each located object is determined. The information obtained in this way about the located object is output via a vehicle interface 28, for example a fast Ethernet interface or a CAN bus, to other electronic components in the vehicle, for example to a driver assistance system. A memory 30 (for example a flash memory or hard disk) enables the storage or at least buffering of evaluation results in the central evaluation unit 20.

In the example shown, each transmit/receive unit 12 has a plurality of semiconductor modules 22, and each semiconductor module has its own raw data interface 14 with associated serializer 16. By way of example, it may be assumed that each semiconductor module 22 pre-evaluates and digitizes the receive signal from forty receive antennas Rx on parallel receive channels. In the serializer 16, the time signals arriving in parallel in the forty channels are serialized and transferred one after the other to the central evaluation unit 20 as a serial signal on a single core of the cable 18. The cable 18 therefore does not need forty cores for each semiconductor module 22, but rather just one single core.

The central evaluation unit 20 has a deserializer 32 for each transmit/receive unit 12, with which the arriving signals are deserialized and then routed onward in parallel to the processor 24.

In the example shown, in addition to the transmit/receive units 12 of the radar system, a video camera V is also provided, the data from which are likewise transferred to the processor 24 and further processed therein.

For control and synchronization functions, the central evaluation unit 20 contains a control unit 34, which receives a time signal from a local real-time clock 36.

Each transmit/receive unit 12 also contains a control unit 38, which receives a time signal from a local real-time clock 40 and drives the semiconductor modules 22.

The control unit 34 of the evaluation unit 20 and the control unit 38 of each transmit/receive unit 12 communicate with one another via one or more cores of the cable 18, which connects these components. In the example shown, each control unit is associated with a serializer/deserializer 42, with which in each case the transmitted signals are serialized and the received signals are deserialized. Since, however, the data exchange which takes place between the control units 34, 38 is on a significantly smaller scale than transfer of the raw data of the semiconductor modules 22, other communication channels and protocols can also be provided for control unit communication.

The local real-time clocks 36, 40 are adjusted relative to one another by occasional exchange of reference signals, such that the transmit/receive units 12 may optionally be synchronized with one another and their data coherently evaluated.

For instance, the processor 24 can also evaluate signals which were transmitted by one of the transmit/receive units and received by the other. Due to the large distance between the transmit/receive units, the two antenna arrays then form an overall array with a very large aperture, which enables high-resolution angle measurement.

What is claimed is:

1. A radar system for a motor vehicle, comprising:
a plurality of transmit/receive units arranged on separate installation supports for installation at various locations in the motor vehicle;
an evaluation system configured to evaluate radar signals received on a plurality of channels in a plurality of processing steps, a first processing step delivering a digital time signal for each channel, which digital time signal represents the received radar signals, and a final processing step delivering as a result location data for individual radar objects and at least the final processing step being implemented for the plurality of transmit/receive units in a central evaluation unit with which each respective transmit/receive unit of the transmit/receive units communicates via a respective raw data interface;
wherein each of the respective raw data interfaces has a serializer, which is configured to transfer raw data from the plurality of channels of the respective transmit/receive unit serially to the central evaluation unit.

2. The radar system as recited in claim 1, wherein at least one of the transmit/receive units has a plurality of semiconductor modules, which each evaluate signals from a number of receive antennas, and in which each of the semiconductor modules is provided with its own serializer.

3. The radar system as recited in claim 1, wherein the central evaluation unit has a deserializer for each of the serializers in the transmit/receive units, the deserializer configured to convert the serially received signals back into parallel signal sequences for further processing in a processor.

4. The radar system as recited in claim 1, wherein the central evaluation unit and each of the transmit/receive units have a control unit configured for controlling functions of the radar system, and the control units of the transmit/receive units are connected to the control unit of the evaluation unit via communication channels.

5. The radar system as recited in claim 4, wherein the communication channels for the control units are separated from the communication channels for the raw data.

6. The radar system as recited in claim 4, wherein the control units of the transmit/receive units are synchronized with one another and with the control unit of the central evaluation unit and the central evaluation unit is configured for coherent evaluation of signals of the transmit/receive units.

7. The radar system as recited in claim 6, wherein the central evaluation unit and each of the transmit/receive units have a local real-time clock for synchronizing the control units.
